(19) United States
(12) Patent Application Publication
(10) Pub. No.: US 2016/0087529 A1
(43) Pub. Date: Mar. 24, 2016

(54) Bootstrap Circuit

(71) Applicant: Sanken Electric Co., LTD., Niiza-shi (JP)

(72) Inventors: Kunitaka Sakai, Niiza-shi (JP); Yuuya Maekawa, Niiza-shi (JP); Masato Hara, Niiza-shi (JP); Hideyuki Kubota, Niiza-shi (JP)

(73) Assignee: Sanken Electric Co., LTD., Niiza-shi (JP)

(21) Appl. No.: 14/490,899

(22) Filed: Sep. 19, 2014

(51) Int. Cl. H02M 3/158

(52) U.S. Cl. CPC H02M 3/158

(57) ABSTRACT

A bootstrap circuit includes an N-channel MOS transistor including: a first N-type semiconductor layer formed on a surface of a P-type semiconductor substrate and electrically connected to a bootstrap capacitor; a P-type semiconductor layer formed on a surface of the first N-type semiconductor layer; a second N-type semiconductor layer formed on a surface of the P-type semiconductor layer; a first electrode electrically connected to the P-type semiconductor layer; a second electrode electrically connected to the second N-type semiconductor layer; and a power-source terminal connected to each of the first electrode and the second electrode for supplying a power-source voltage thereto, the N-channel MOS transistor supplying power to the bootstrap capacitor, and a current limiting element connected between the power-source terminal and the first electrode.

### TECHNICAL FIELD

This disclosure relates to a bootstrap circuit used in a driving circuit for driving a power device or the like

### BACKGROUND

In general, a charging element (diode or transistor) for charging a bootstrap capacitor in a bootstrap circuit is provided outside a high withstand voltage IC (integrated circuit) chip.

Contrarily, J P 2006-5182 A discloses a type in which a P-channel MOS (metal-oxide-semiconductor) transistor as a charging element is equipped within a high withstand voltage IC chip is disclosed.

### SUMMARY

A high withstand voltage IC chip has a configuration in which P-type and N-type semiconductor regions are complicatedly formed in a semiconductor substrate. Therefore, if a charging element configured by a MOS transistor is equipped within the high withstand voltage IC chip, a parasitic element is formed by a source region or a drain region of the MOS transistor and semiconductor regions within the semiconductor substrate.

Depending on an operation state of the charging element, there is a possibility that the parasitic element is operated so that an electric power is wastefully consumed and a withstand voltage of the element is reduced.

In JP 2006-5182 A, the P-channel MOS transistor is employed as a charging element, but it has been not considered that an N-channel MOS transistor is employed as a charging element.

This disclosure has been made with consideration of the above and provides a bootstrap circuit, in which power consumption can be reduced and a withstand voltage thereof can be sufficiently ensured, in a bootstrap circuit employing an N-channel MOS transistor as a charging element.

A bootstrap circuit according to this disclosure includes an N-channel MOS transistor including: a first N-type semiconductor layer formed on a surface of a P-type semiconductor substrate and electrically connected to a bootstrap capacitor; a P-type semiconductor layer formed on a surface of the first N-type semiconductor layer; a second N-type semiconductor layer formed on a surface of the P-type semiconductor layer; a first electrode electrically connected to the P-type semiconductor layer; a second electrode electrically connected to the second N-type semiconductor layer; and a power-source terminal connected to each of the first electrode and the second electrode for supplying a power-source voltage thereto, the N-channel MOS transistor supplying power to the bootstrap capacitor, and a current limiting element connected between the power-source terminal and the first electrode.

According to this disclosure, it is possible to provided a bootstrap circuit, in which power consumption can be reduced and a withstand voltage thereof can be sufficiently ensured, in a bootstrap circuit employing an N-channel MOS transistor as a charging element.

### BRIEF DESCRIPTION OF DRAWINGS

FIG. 1 is a view showing a configuration of a switching module to which a semiconductor device according to an embodiment of this disclosure is applied.

FIG. 2 is a schematic sectional view showing a detailed configuration of a periphery of an N-channel MOS transistor 1 of an IC chip 100 shown in FIG. 1.

FIG. 3 is a schematic sectional view showing a first modified embodiment of the detailed configuration of the periphery of the N-channel MOS transistor 1 of the IC chip 100 shown in FIG. 1.

FIG. 4 is a schematic sectional view showing a second modified embodiment of the detailed configuration of the periphery of the N-channel MOS transistor 1 of the IC chip 100 shown in FIG. 1.

FIG. 5 is a schematic sectional view showing a third modified embodiment of the detailed configuration of the periphery of the N-channel MOS transistor 1 of the IC chip 100 shown in FIG. 1.

### DESCRIPTION OF EMBODIMENTS

Embodiments of this disclosure will be now described with reference to the drawings.

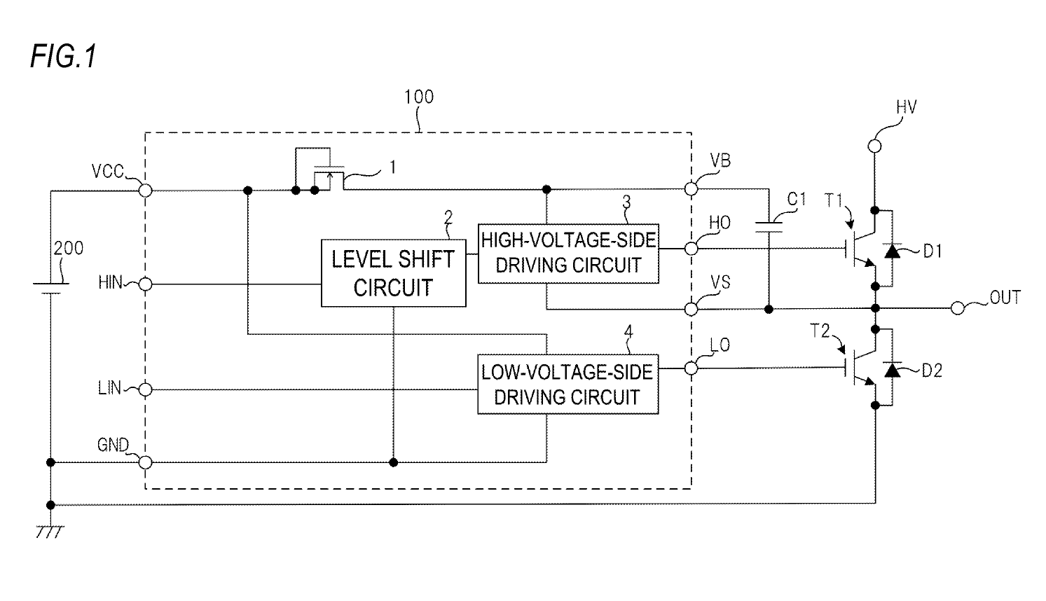

FIG. 1 is a view showing one example of a switching module in which a semiconductor device according to an embodiment of this disclosure is combined with a power device.

The switching module in FIG. 1 has an IC chip 100 as a semiconductor device having a power-source terminal VCC and a ground terminal GND, between which a power source 200 is connected, a bootstrap capacitor C1 connected between a power-source terminal VB and a high voltage reference terminal VS of the IC chip 100, and a power device including a transistor T1 having a gate electrode connected to a high voltage output terminal HO of the IC chip 100 and a transistor T2 having a gate electrode connected to a low voltage output terminal LO of the IC chip 100.

The transistor T1 and the transistor T2 are connected in series between a main power-source terminal HV and the ground terminal, and the transistors T1 and T2 have respective substrate diodes D1 and D2.

The IC chip 100 has an N-channel MOS transistor 1, a level shift circuit 2, a high-voltage-side driving circuit 3 and a low-voltage-side driving circuit 4.

The N-channel MOS transistor 1 has a source, a gate and a back gate, which are connected to the power-source terminal VCC, and a drain connected to the terminal VB. The N-channel MOS transistor 1 operates in the same manner as a PN junction diode and is provided to supply an electric power to the bootstrap capacitor C1.

The N-channel MOS transistor 1 is turned on to charge the bootstrap capacitor C1 in a state where the bootstrap capacitor C1 has not been charged and where a voltage of the terminal VCC is greater than a voltage of the terminal VB (hereinafter, referred to as an initial state). Incidentally, the N-channel MOS transistor 1 is turned off to ensure a withstand voltage in a state where the transistor T1 has been turned on and where a voltage of the terminal VCC is smaller than a voltage of the terminal VB (hereinafter, referred to as a high voltage state).

The high-voltage-side driving circuit 3 is operated by a voltage of the terminal VB and outputs a driving signal to the terminal HO in response to a timing signal supplied from the level shift circuit 2, thereby driving the transistor T1.

In a state where the transistor T2 has been turned off, the high-voltage-side driving circuit 3 is operated by a voltage held in the bootstrap capacitor C1 and outputs a driving signal to the terminal HO in response to a timing signal inputted from a high voltage input terminal HIN.

The low-voltage-side driving circuit 4 is operated by a voltage inputted from the power-source terminal VCC and outputs a driving signal to the terminal LO in response to a timing signal inputted from a low voltage input terminal LIN, thereby driving the transistor T2.

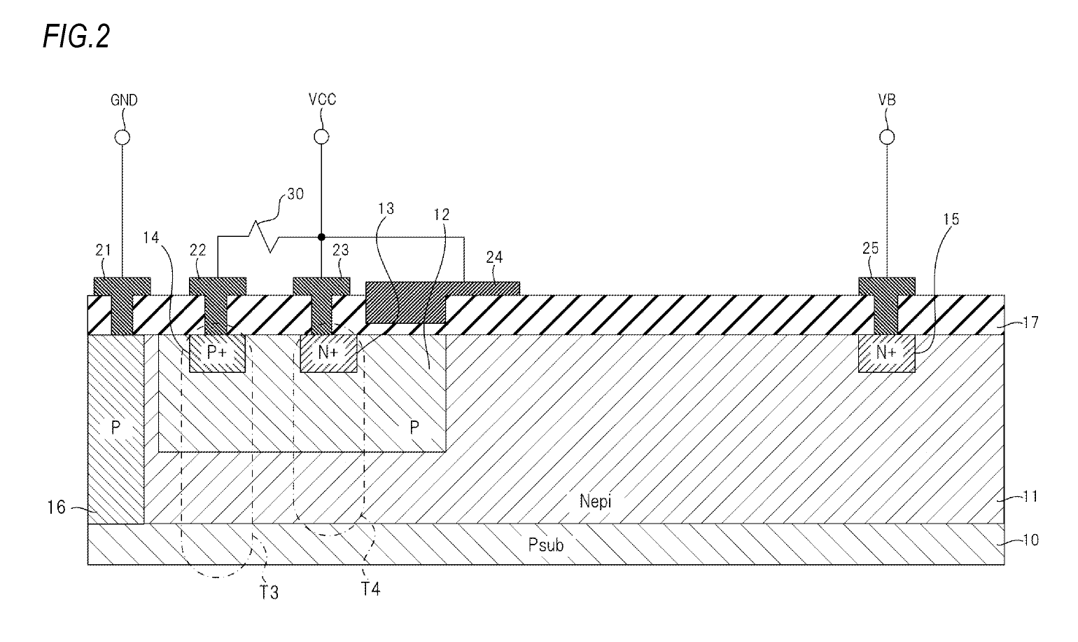

FIG. 2 is a schematic sectional view showing a detailed configuration of a periphery of the N-channel MOS transistor 1 of the IC chip 100 shown in FIG. 1.

A semiconductor region of the N-channel MOS transistor 1 has a N-type semiconductor layer 11 formed on a surface of a P-type semiconductor substrate 10, for example, by epitaxial growth, a P-type semiconductor layer 12 formed on a surface of the N-type semiconductor layer 11, a N-type semiconductor layer 13 formed on a surface of the P-type semiconductor layer 12 and having an impurity concentration higher than the N-type semiconductor layer 11, a P-type semiconductor layer 14 formed on a surface of the P-type semiconductor layer 12 to be spaced from the N-type semiconductor layer 13 and having an impurity concentration higher than the P-type semiconductor layer 12, and a N-type semiconductor layer 15 formed on a surface of the N-type semiconductor layer 11 to be spaced from the P-type semiconductor layer 12 and having an impurity concentration higher than the N-type semiconductor layer 11, and the layers are isolated from another element by an element isolation layer 16.

The N-type semiconductor layer 11 and the N-type semiconductor layer 15 configure a first N-type semiconductor layer in the claims. The P-type semiconductor layer 12 and the P-type semiconductor layer 14 configure a P-type semiconductor layer in the claims. The N-type semiconductor layer 14 configures a second N-type semiconductor layer in the claims.

Meanwhile, the N-type semiconductor layer 13 configures the source of the N-channel MOS transistor 1. The N-type semiconductor layer 15 configures the drain of the N-channel MOS transistor 1. The P-type semiconductor layer 14 configures the back gate of the N-channel MOS transistor 1.

A wiring region of the N-channel MOS transistor 1 has: a gate electrode 24 formed above a semiconductor layer between the N-type semiconductor layer 13 and the N-type semiconductor layer 15 with interposing an insulating film 17; a back gate 22 being a first electrode electrically connected to the P-type semiconductor layer 14; a source electrode 23 being a second electrode electrically connected to the N-type semiconductor layer 13; and a drain electrode 25 electrically connected to the N-type semiconductor layer 15.

The back gate 22 is connected to the power-source terminal VCC via a resistor element 30 as a current limiting element. Each of the source electrode 23 and the gate electrode 24 is connected to the power-source terminal VCC. The drain electrode 25 is connected to the terminal VB in FIG. 1.

The IC chip 100 in FIG. 1 has additionally an electrode 21 electrically connected to the element isolation layer 16, and the electrode 21 is connected to the GND terminal.

In the IC chip 100 configured as described above, a parasitic transistor T3 is formed by PNP junction of the P-type semiconductor layers 14 and 12, the N-type semiconductor layer 11 and the P-type semiconductor substrate 10.

Therefore, in the initial state where a voltage of the power-source terminal VCC is greater than a voltage of the terminal VB, the parasitic transistor T3 is operated and thus an electric current flows from the power-source terminal VCC to the semiconductor substrate via the back gate 22.

If such electric current is increased, power consumption is also increased, but the resistor element 30 is connected between the back gate 22 and the power-source terminal VCC. Therefore, an amount of the electric current flowing from the power-source terminal VCC to the semiconductor substrate is limited by the resistor element 30. As a result, an increase in power consumption can be suppressed.

Meanwhile, in the configuration shown in FIG. 2, a parasitic transistor T4 is also formed due to NPN junction of the N-type semiconductor layer 13, the P-type semiconductor layer 12 and the N-type semiconductor layer 11.

When the transistor T1 is turned on by receiving a signal of the terminal HIN and thus the initial state is switched into the high voltage state, a recovery current flows from the terminal VB to the back gate 22 via a PN junction capacity of the P-type semiconductor layers 12 and 14 and the N-type semiconductor layers 11 and 15.

If the recovery current flows through the resistor element 30, a potential of the back gage 22 is increased. Along with such an increase in potential, an electric current flows from the N-type semiconductor layer 11 to the N-type semiconductor layer 13 in the parasitic transistor T4.

Then, when the potential continues to increase so that the parasitic transistor T4 becomes a secondary breakdown state, the electric current continues to flow from the N-type semiconductor layer 11 to the N-type semiconductor layer 13.

In addition, when the IC chip 100 is at a high temperature, a leakage current flows from the terminal VB to the back gate 22 via a PN junction capacity of the P-type semiconductor layers 12 and 14 and the N-type semiconductor layers 11 and 15.

As the leakage current flows through the resistor element 30, a potential of the back gage 22 is increased and thus the parasitic transistor T4 is operated, so that an electric current flows from the N-type semiconductor layer 11 to the N-type semiconductor layer 13. Therefore, a withstand voltage of the IC chip 100 is apparently decreased at the high temperature.

Hereinafter, variants of the IC chip 100 for solving the above problems will be described.

### First Modified Embodiment

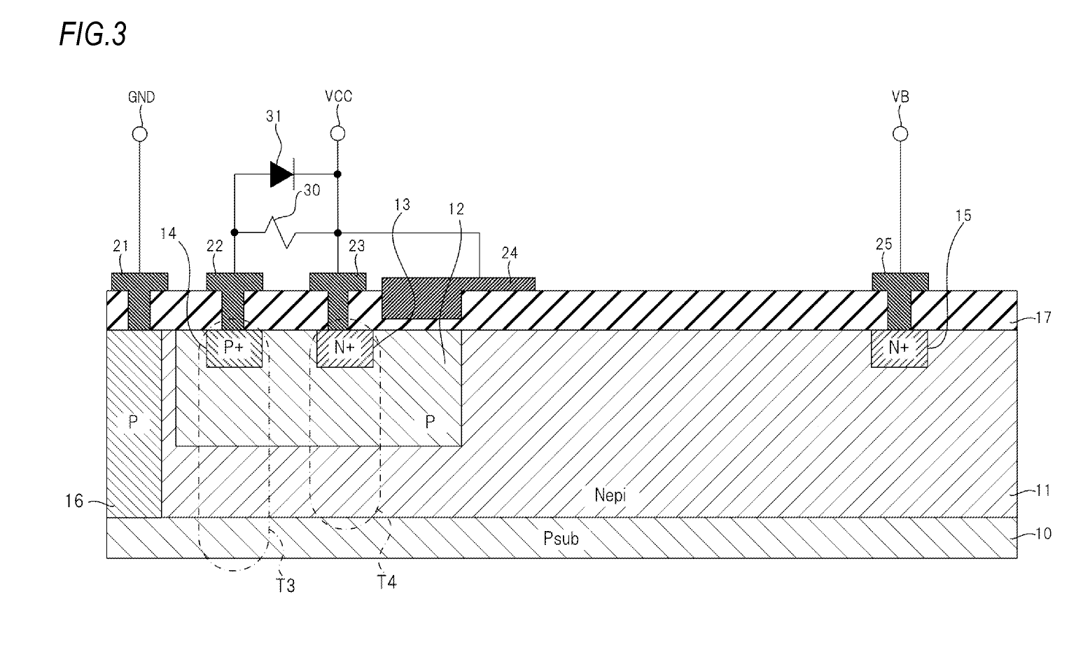

FIG. 3 is a schematic sectional view showing a first modified embodiment of the detailed configuration of the IC chip 100 shown in FIG. 1. In FIG. 3, the same components as those in FIG. 2 are designated by the same reference numeral and the descriptions thereof will be omitted.

An IC chip 100 shown in FIG. 3 is identical to those in FIG. 2, except that a diode 31 as a circuit element is added between the power-source terminal VCC and the back gate 22 to be connected in parallel to the resistor element 30.

The diode 31 has an anode connected to the back gate 22 and a cathode connected to the power-source terminal VCC. Thus, it is possible to cause a recovery current or a leakage current, which would otherwise have flowed from N-type semiconductor layers 11 and 15 to the back gate 22 via P-type semiconductor layers 12 and 14, to flow toward the power-source terminal VCC and so as to suppress an electric current supplied from the power-source terminal VCC from flowing to the back gate 22.

Due to the diode 31, a potential of the back gate 22 can be suppressed from being increased at a high temperature or the high voltage state. Therefore, a parasitic transistor T4 can be suppressed from becoming a secondary breakdown state and thus continuing to cause an electric current to flow therethrough, or the parasitic transistor T4 can be suppressed from being operated to reduce a withstand voltage, thereby enhancing reliability of the product. Meanwhile, since the diode 31 does not flow an electric current from the power-source terminal VCC, there is no problem in a normal operation.

### Second Modified Embodiment

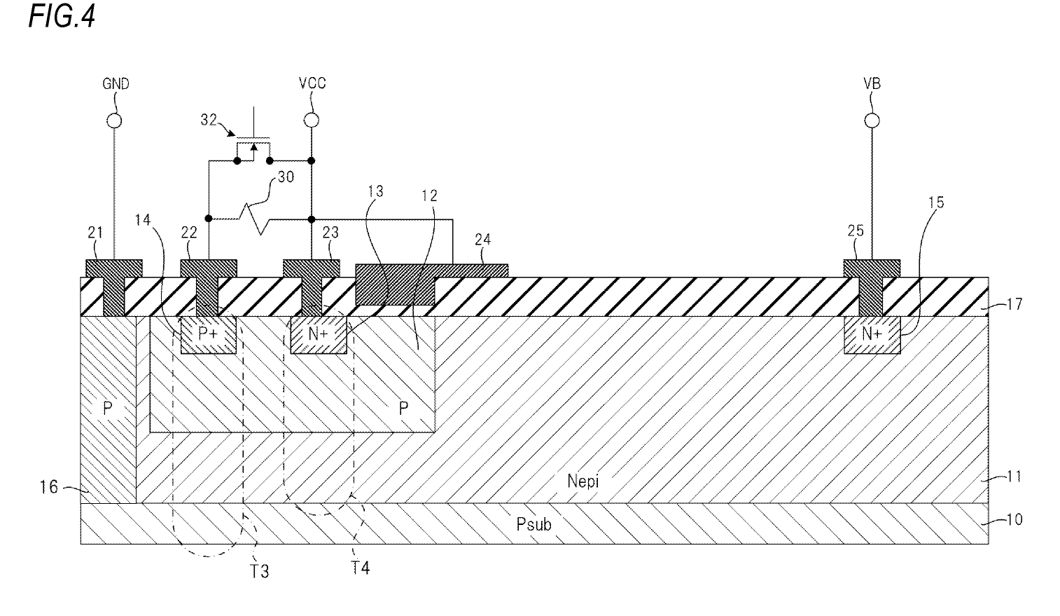

FIG. 4 is a schematic sectional view showing a second modified embodiment of the detailed configuration of the IC chip 100 shown in FIG. 1. In FIG. 4, the same components as those in FIG. 2 are designated by the same reference numeral and the descriptions thereof will be omitted.

An IC chip 100 shown in FIG. 4 is identical to those in FIG. 2, except that a N-channel MOS transistor 32 as a circuit element is added between the power-source terminal VCC and the back gate 22 to be connected in parallel to the resistor element 30.

The N-channel MOS transistor 32 has a source connected to the back gate 32 and a drain connected to the power-source terminal VCC. Meanwhile, the IC chip 100 is provided with a timing detection circuit, not shown, adapted to output a high level signal when a timing of transiting from the initial state to the high voltage state is detected. An output signal of the timing detection circuit is connected to a gate of the N-channel MOS transistor 32.

The N-channel MOS transistor 32 is turned on when the high level signal is inputted to the gate thereof. Thus, it is possible to cause a recovery current, which would otherwise have flowed from the N-type semiconductor layer 11 to the back gate 22 via P-type semiconductor layers 12 and 14, to flow toward the power-source terminal VCC and so as to suppress an electric current supplied from the power-source terminal VCC from flowing to the back gate 22.

Meanwhile, the N-channel MOS transistor 32 is turned off when a low level signal is inputted to the gate thereof. Thus, a normal operation is not impeded. Meanwhile, the N-channel MOS transistor 32 needs have an on resistance smaller than a resistance of the resistor element 30. Incidentally, the N-channel MOS transistor 32 may be substituted with a P-channel type.

### Third Modified Embodiment

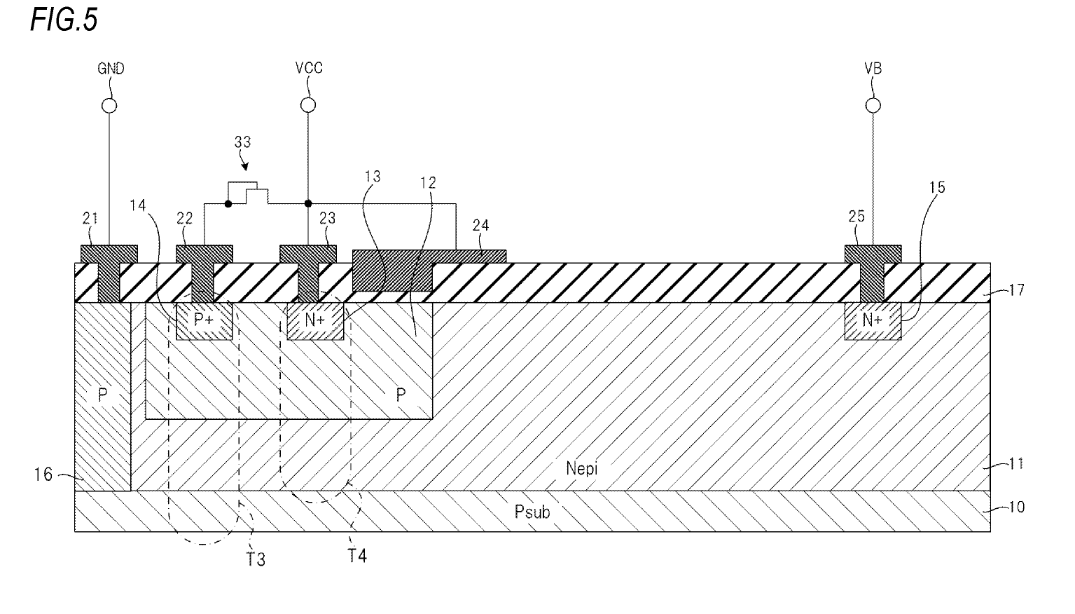

FIG. 5 is a schematic sectional view showing a third modified embodiment of the detailed configuration of the IC chip 100 shown in FIG. 1. In FIG. 5, the same components as those in FIG. 2 are designated by the same reference numeral and the descriptions thereof will be omitted.

An IC chip 100 shown in FIG. 5 is identical to those in FIG. 2, except that instead of the resistor element 30, a JFET (Junction-FET) 33 as a current limiting element is connected between the back gate 22 and the power-source terminal VCC.

The JFET 33 has a source and a gate, which are connected to the back gate 22, and a drain connected to the power-source terminal VCC.

At the initial state, an amount of electric current flowing from the drain of the JFET 33 to the source thereof is limited to a saturation current of the JFET 33. Thus, the same effects as those of the resistor element 30 can be obtained.

Meanwhile, at the high voltage state, an electric current can flow through a PN junction between the gate and the drain of the JFET 33, thereby obtaining the same effects as those of the diode 31 in the second variant.

### Fourth Modified Embodiment

A detailed configuration of an IC chip 100 according to this modified embodiment is identical to those in FIG. 2, except that a condition with respect to a resistance value of the resistor element 20 is set.

The resistance value of the resistor element 30 is set to have a magnitude so as to suppress the parasitic transistor T4 from becoming a secondary breakdown state due to an electric current flowing from N-type semiconductor layers 11 and 15 to the back gate 22 via P-type semiconductor layers 12 and 14. By doing so, reliability of the IC chip 100 can be enhanced without adding circuit elements as illustrated in FIGS. 3 and 4.

Alternatively, the resistance value of the resistor element 30 may be set to have a magnitude so as to suppress the parasitic transistor T4 from being turned on due to an electric current flowing from N-type semiconductor layers 11 and 15 to the back gate 22 via P-type semiconductor layers 12 and 14. By doing so, since the parasitic transistor T4 is not turned on, the above problems can be solved and reliability of the IC chip 100 can be enhanced.

Even in configurations of FIGS. 2 to 4, at the initial state, a slight electric current flows from the power-source terminal VCC to the back gate 22 via the resistor element 30 and thus the parasitic transistor T3 is operated, thereby consuming an electric power. Therefore, the resistance value of the resistor element 30 is preferably set to have a range in which power consumption does not cause problems in applications.

In the foregoing, although specific embodiments of this disclosure have been explained, such embodiments are only examples, and various changes and modifications thereof may be made without departing from the spirit and the scope of the disclosure. For example, the P-type semiconductor layer 14 in FIG. 2 is provided to have a good contact between the substrate and the back gate 22, and therefore may be omitted. In addition, the diode 31 in FIG. 3 may be a transistor having a gate and a source short-circuited therebetween, like the N-channel MOS transistor 1.

As described above, the followings are disclosed herein.

The disclosed bootstrap circuit includes an N-channel MOS transistor including: a first N-type semiconductor layer formed on a surface of a P-type semiconductor substrate and electrically connected to a bootstrap capacitor; a P-type semiconductor layer formed on a surface of the first N-type semiconductor layer; a second N-type semiconductor layer formed on a surface of the P-type semiconductor layer; a first electrode electrically connected to the P-type semiconductor layer; a second electrode electrically connected to the second N-type semiconductor layer; and a power-source terminal connected to each of the first electrode and the second electrode for supplying a power-source voltage thereto, the N-channel MOS transistor supplying power to the bootstrap capacitor, and a current limiting element connected between the power-source terminal and the first electrode.

The disclosed bootstrap circuit further includes a circuit element connected in parallel to the current limiting element between the power-source terminal and the first electrode, wherein the circuit element is an element possible to cause an electric current, which would be flowed from the first N-type semiconductor layer to the first electrode via the P-type semiconductor layer, to flow toward the power-source terminal, and so as to suppress an electric current supplied from the power-source terminal from flowing to the first electrode.

In the disclosed bootstrap circuit, the circuit element is a diode having an anode connected to the first electrode and a cathode connected to the power-source terminal.

In the disclosed bootstrap circuit, the circuit element is a transistor, of which a gate voltage is controlled.

In the disclosed bootstrap circuit, the current limiting element is a resistor element, wherein a resistance valve of the resistor element is set to have a magnitude so as to suppress a parasitic transistor, which is formed by NPN junction of the second N-type semiconductor layer, the P-type semiconductor layer and the first N-type semiconductor layer, from becoming a secondary breakdown state due to an electric current flowing from the first N-type semiconductor layer to the first electrode via the P-type semiconductor layer.

In the disclosed bootstrap circuit, the current limiting element is a resistor element, wherein a resistance valve of the resistor element is set to have a magnitude so as to suppress a parasitic transistor, which is formed by NPN junction of the second N-type semiconductor layer, the P-type semiconductor layer and the first N-type semiconductor layer, from being turned on due to an electric current flowing from the first N-type semiconductor layer to the first electrode via the P-type semiconductor layer.

In the disclosed bootstrap circuit, the current limiting element is a JFET having a drain, which is connected to the power-source terminal, and a source and a gate, which are connected to the first electrode.

1. A bootstrap circuit comprising:
an N-channel MOS transistor including:
a first N-type semiconductor layer formed on a surface of a P-type semiconductor substrate and electrically connected to a bootstrap capacitor;
a P-type semiconductor layer formed on a surface of the first N-type semiconductor layer;
a second N-type semiconductor layer formed on a surface of the P-type semiconductor layer;
a first electrode electrically connected to the P-type semiconductor layer;
a second electrode electrically connected to the second N-type semiconductor layer; and
a power-source terminal connected to each of the first electrode and the second electrode for supplying a power-source voltage thereto, the N-channel MOS transistor supplying power to the bootstrap capacitor, and
a current limiting element connected between the power-source terminal and the first electrode.

2. The bootstrap circuit according to claim 1, further comprising
a circuit element connected in parallel to the current limiting element between the power-source terminal and the first electrode,
wherein the circuit element is an element possible to cause an electric current, which would be flowed from the first N-type semiconductor layer to the first electrode via the P-type semiconductor layer, to flow toward the power-source terminal, and so as to suppress an electric current supplied from the power-source terminal from flowing to the first electrode.

3. The bootstrap circuit according to claim 2,
wherein the circuit element is a diode having an anode connected to the first electrode and a cathode connected to the power-source terminal.

4. The bootstrap circuit according to claim 2,
wherein the circuit element is a transistor, of which a gate voltage is controlled.

5. The bootstrap circuit according to claim 1,
wherein the current limiting element is a resistor element,
wherein a resistance valve of the resistor element is set to have a magnitude so as to suppress a parasitic transistor, which is formed by NPN junction of the second N-type semiconductor layer, the P-type semiconductor layer and the first N-type semiconductor layer, from becoming a secondary breakdown state due to an electric current flowing from the first N-type semiconductor layer to the first electrode via the P-type semiconductor layer.

6. The bootstrap circuit according to claim 1,
wherein the current limiting element is a resistor element,
wherein a resistance valve of the resistor element is set to have a magnitude so as to suppress a parasitic transistor, which is formed by NPN junction of the second N-type semiconductor layer, the P-type semiconductor layer and the first N-type semiconductor layer, from being turned on due to an electric current flowing from the first N-type semiconductor layer to the first electrode via the P-type semiconductor layer.

7. The bootstrap circuit according to claim 1,
wherein the current limiting element is a JFET having a drain, which is connected to the power-source terminal, and a source and a gate, which are connected to the first electrode.
